(19) United States
(12) Patent Application Publication
(10) Pub. No.: US 2021/0071816 A1
(43) Pub. Date: Mar. 11, 2021

(54) LIQUEFIED GAS STORAGE AND DELIVERY SYSTEM

(71) Applicant: Parfitt Engineering Design Ltd., Fleet (GB)

(72) Inventor: Stefan Witold PARFITT, Waco, TX (US)

(21) Appl. No.: 17/017,077

(22) Filed: Sep. 10, 2020

(30) Foreign Application Priority Data
Sep. 11, 2019 (GB) 1913187.9

(51) Int. Cl. F17C 9/02; F17C 1/12

(52) U.S. Cl. CPC F17C 9/02; F17C 1/12; F17C 2221/035; F17C 2223/033; F17C 2221/033; F17C 2223/0161

(57) ABSTRACT

A self-pressurising storage vessel is provided comprising a storage tank for storing a cryogen and a cooling jacket, wherein the cooling jacket is for holding a substance suitable for cooling the cryogen, arranged such that, in use, vapour evaporated from the substance in the cooling jacket pressurises the storage tank.

### BACKGROUND OF THE INVENTION

Aspects of the invention relate to devices and systems for liquefied gas storage and injection. Aspects of the invention have particular relevance to gas injection where there is currently no viable alternative to conventional fossil fuels.

Internal combustion engines are prime movers in the powertrains of many heavy-duty vehicles and have dominated markets on the basis of operational cost and performance for many years. Historically, the growth in electric powertrains has been slow although this is changing. Short range or light-duty vehicles are well suited to the low specific energy storage densities that can be provided with chemical batteries. Certain heavy-duty applications such as rail are also suited to electrification, but are limited to operate only within the available infrastructure. Aside from several exceptions, internal combustion engines burning hydrocarbon fuels remain the only viable method for producing power, especially for heavy-duty applications, and will continue to do so for the foreseeable future.

Emissions resulting from combustion and the security of fuel supplies are often provided as the main objections for continuing to rely on the internal combustion engine. These are addressed by exploiting alternative fuels, such as liquid petroleum gas as well as much colder liquids or cryogens including liquid natural gas, liquid bio methane and even liquid nitrogen. The liquefaction of gasses and the production of cryogens is an excellent way to improve stored energy densities. However, cryogens are hazardous substances. They typically boil at very low temperatures and spontaneously generate vapour that displaces breathable oxygen. These vapours can also be flammable depending on the chemistry of the gas. They can rapidly vaporise in bulk or ‘roll-over’—dangerously pressurising connected systems. Their low temperature can condense and freeze water vapour and even carbon dioxide on exposed cold surfaces clogging ducts and pipes as well as seize mechanical components. They also require significant amounts of energy to liquefy in the first place.

Challenges exist for controlling where boiling and vaporisation occur, avoiding the risk of roll-over in storage, and the general handling of very low temperatures liquids. When cryogens are applied to fueling heavy duty vehicles powered by internal combustion engines, these challenges can be exploited to improve the performance of the internal combustion engine and entire vehicle when using the novel concepts described herein.

### SUMMARY OF THE INVENTION

According to a first aspect of the invention, there is provided a self-pressurising storage vessel comprising: a storage tank (108) for storing a cryogen; and a cooling jacket (138), wherein the cooling jacket (138) is for holding a substance suitable for cooling the cryogen, arranged such that, in use, vapour evaporated from the substance in the cooling jacket (138) pressurises the storage tank.

Optionally, the cooling jacket is positioned around and in contact with said storage tank.

Optionally, the self-pressurising storage vessel comprises control means for feeding vapour from the cooling jacket into the storage tank, utilising a valve and pressure gauge to maintain a positive pressure in the storage tank.

Optionally, the cooling jacket sub-cools the cryogen, wherein the sub-cooled cryogen is in the solid and/or liquid phase.

Optionally, the substance is liquid nitrogen, LN2, and wherein the cryogen is one of methane, liquid natural gas, LNG, propane or butane.

Optionally, the storage tank further comprises a heating means, wherein the heating means optionally comprises a number of individually controlled/heated concentric rings situated within the storage tank.

Optionally, the number of individually controlled/heated concentric rings may be made from a porous metal matrix.

An internal combustion engine comprising the self pressurising storage vessel of the first aspect of the invention.

A method (700) for pressurising a storage vessel according to the first aspect of the invention, the method comprising: storing (702) a cryogen in a storage vessel; utilising (704) a cooling jacket to cool the cryogen in the storage vessel, the cooling jacket comprising a substance suitable for cooling the cryogen; and pressurising (706) the storage vessel using vapour evaporated from the substance.

According to a second aspect of the invention, there is provided a thermo-fluidic pump arrangement (342) comprising: a pressure chamber (448) for holding a cryogen; a heating means (452); and a cooling means (450); wherein the cooling means (450) sub-cools a portion (462) of the pressure chamber (448) in order to reduce the pressure in the pressure chamber (448) so as to draw a cryogen into the pressure chamber (448); and wherein the heating means (452) heats the portion (462) of the pressure chamber (448) in order to increase the pressure in the pressure chamber so as to expel the cryogen from the pressure chamber (448).

Optionally, the cryogen is sub-cooled fuel, wherein the sub-cooled fuel is one of methane, liquid natural gas, LNG, propane or butane.

Optionally, the pressure chamber comprises a vaporising column (462), wherein the heating means and cooling means are arranged at the vaporising column.

Optionally, the heating means is arranged to be in contact with cryogen in the pressure chamber, and wherein the cooling means is arranged to be in contact with the vaporising column.

Optionally, the cooling means is arranged to be in contact with the vapour within the vaporising column.

An internal combustion engine comprising the thermo-fluidic pump arrangement of the second aspect of the invention.

An internal combustion engine comprising the self pressurising storage vessel of the first aspect of the invention and the thermo-fluidic pump arrangement of the second aspect of the invention.

A method (800) for pumping a cryogen according to the second aspect of the invention, the method comprising: storing (802) a cryogen in a pressure chamber; cooling (804) a portion of the cryogen in the pressure chamber in order to reduce the pressure in the pressure chamber; drawing (806) cryogen into the pressure chamber as a result of the reduction in pressure in the pressure chamber; heating (808) a portion of the cryogen in the pressure chamber in order to increase the pressure in the pressure chamber; and expelling (810) cryogen from the pressure chamber as a result of the increase in pressure in the pressure chamber.

According to a third aspect of the invention, there is provided a cooling jacket (138) for a storage tank, wherein the cooling jacket (138) is for positioning around said storage tank, wherein said cooling jacket (138) is for holding a substance suitable for cooling a cryogen, wherein vapour evaporated from the substance in the cooling jacket pressurises the storage tank.

According to a fourth aspect of the invention, there is provided a thermo-fluidic pump arrangement comprising: a pressure chamber (586) for holding a cryogen; heating means (570); vapour accelerating means (580); decelerating means (578); and pumping means (576); wherein the heating means (570) is arranged to vaporise a portion of the cryogen in the pressure chamber, said vapour being forwarded to the vapour accelerating means (580); said pumping means (576) arranged to receive said accelerated vapour and arranged to facilitate mixing of said accelerated vapour with a fluid, wherein said fluid condenses said accelerated vapour in said pump means to form a resultant cryogen, said resultant cryogen being decelerated by said decelerating means and input into the pressure chamber at a pressure higher than the cryogen remaining in the pressure chamber.

A method (900) for pumping a cryogen according to the fourth aspect of the invention, the method comprising: heating (902) a portion of a first cryogen in a pressure chamber to form a vapour; accelerating (904) said vapour; mixing (906) said accelerated vapour with a fluid, wherein said fluid condenses said accelerated vapour to form a resultant cryogen; decelerating said resultant cryogen and injecting into the pressure chamber, wherein decelerating said resultant cryogen raises its pressure above that of the remaining first cryogen in the pressure chamber.

Optionally, the cryogen and the fluid are the same liquid fuel, and wherein the fluid is sub-cooled.

An internal combustion engine comprising the thermo-fluidic pump arrangement of the fourth aspect of the invention.

An internal combustion engine comprising the self pressurising storage vessel of the first aspect of the invention and the thermo-fluidic pump arrangement of the fourth aspect of the invention.

### BRIEF DESCRIPTION OF THE DRAWINGS

By way of example, aspects of the invention will now be described in detail with reference to the accompanying drawings, in which:

FIG. 1 is a diagram of a self-pressurising storage vessel.

FIG. 2 is a diagram of an alternative self-pressurising storage vessel.

FIG. 3 is a diagram of a pumping means, which may be used separately or in combination with the self-pressurising storage vessel of FIGS. 1 and 2.

FIG. 4 is a more detailed diagram of the pumping means from FIG. 3.

FIG. 5 is a diagram of an alternative pumping means, which may be used separately or in combination with the self-pressurising storage vessel of FIGS. 1 and 2 and the pumping means from FIGS. 3 and 4.

FIG. 6 is a diagram of an alternative pumping means, which may be used separately or in combination with the self-pressurising storage vessel of FIGS. 1 and 2 and the pumping means from FIGS. 3 and 4.

FIG. 7 illustrates a flow chart 700 for pressurising a storage vessel, for example the self pressurising storage vessel from the first aspect of the invention relating to FIGS. 1 and 2.

FIG. 8 illustrates a flow chart 800 for pumping a fluid. FIG. 8 relates to the apparatus described with respect to FIGS. 3 and 4.

FIG. 9 illustrates a flow chart 900 for pumping a fluid. FIG. 9 relates to the apparatus described with respect to FIGS. 5 and 6.

### DETAILED DESCRIPTION OF THE INVENTION

The below aspects are relevant to the liquid air and gas/oil industries. Temperature ranges of interest include anything from the saturation temperature of liquid nitrogen (LN2), which is 77K at 1 atm, to the saturation temperature of liquid natural gas (LNG), which is 111K at 1 atm, or greater, such as liquid petroleum gas (LPG), which has a saturation temperature of 231K at 1 atm. In the below aspects, the term “cryogen” refers to a liquid or a solid form of a substance more usually encountered as a gas, and characterised by a very low boiling point, for example nitrogen, natural gas and petroleum gas. Thus the term “cryogen” can, for example, refer to fluid that has been sub-cooled (below the temperature of the normal boiling point) or frozen.

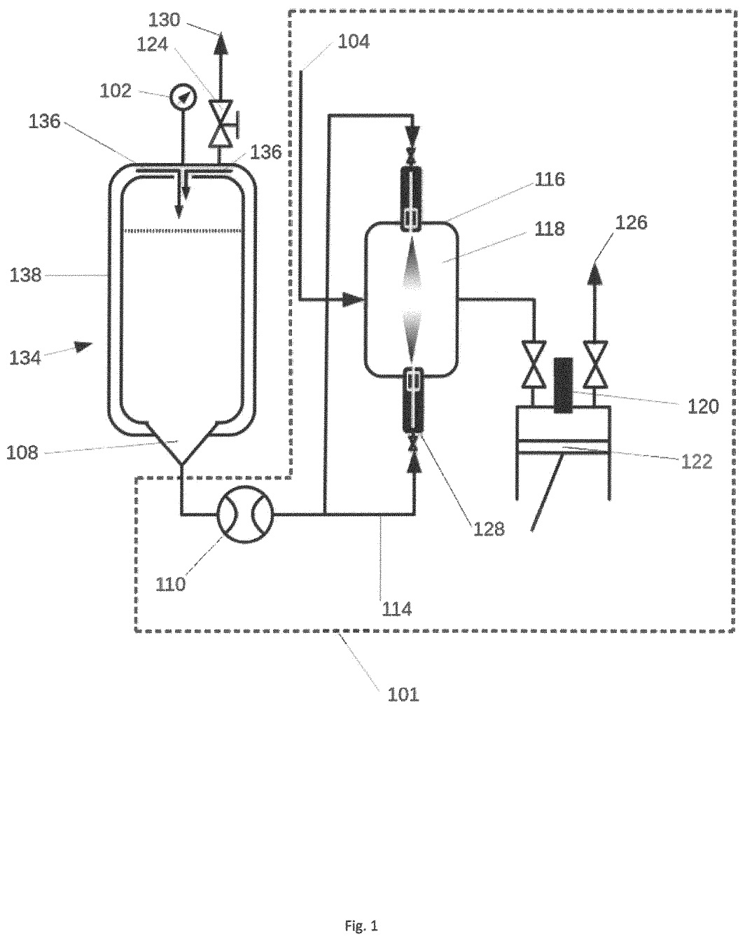

A first aspect of the invention will now be described with reference to FIG. 1. FIG. 1 illustrates a self-pressurising storage vessel 134 coupled to an optional fuel system 101, which is illustrated to provide an example operation of the self-pressurising storage vessel 134 with a fuel system. The fuel system 101 comprises fuel mixing means, for example a plenum 118, and an internal combustion engine 122, wherein the plenum 118 is arranged to provide fuel to the internal combustion engine 122. We note that references to an internal combustion engine are merely exemplary. For example, the self-pressurising storage vessel 134 described throughout this application may deliver fluid, such as fuel, to a boiler or a combustor as well as an internal combustion engine. The fluid may be a liquefied gas such as methane, liquid natural gas, LNG, propane or butane, for example. In some examples, the fluid is sub-cooled, which means that the fluid is cooled below the saturation temperature of the fluid, i.e., the fluid is not stored as a boiling liquid. In these examples, the fluid is preferably a cryogen, which may be stored in a liquid or a solid (frozen) phase.

The self-pressurising storage vessel 134 comprises a storage tank 108 for storing the fluid, which will be described from now on with respect to a fuel/cryogen, and a cooling jacket 138. The cooling jacket 138 is arranged to hold a cooling substance that is suitable for cooling the fuel, preferably sub-cooling the fuel. Preferably the cooling jacket 138 surrounds a majority of the external surface area of the storage tank 108 so that the cooling effect of the cooling jacket 138 is maximised. The cooling substance in the cooling jacket 138 may be separated from the fuel via the storage tank 108. The substance is preferably liquid nitrogen, LN2. In a preferred example, the liquid nitrogen is arranged to sub-cool the liquid fuel, which is preferably a cryogen, in the storage tank 108. The liquid fuel may be sub-cooled liquid natural gas, LNG. During the cooling process, a portion of the liquid nitrogen will boil, releasing a boil-off gas/vapour. Advantageously, this boil-off gas/vapour from the cooling substance in the cooling jacket 138 can be fed 136 into the storage tank 108. Preferably the vapour will be pressurised nitrogen vapour, wherein the vapour generated in the cooling jacket 138 is naturally allowed to self-pressurise the storage tank 108 as it boils. We note that it is not essential that the vapour be actively fed into the system as pressurised nitrogen. A valve 124 and pressure gauge 102 can be utilised to regulate pressure in the storage tank 108 due to the incorporation of the boil-off gas/vapour 136 from the cooling substance. Advantageously, the incorporation of the boil-off gas 136 into the storage tank 108 enables the storage tank 108 to maintain a positive tank pressure, for example in the range of around 1-15 bar. This has an effect of keeping oxygen out of the system, which has an advantage of eliminating the risk of oxygen contamination. Control means, such as a control system, may be used to control the valve 124 utilising the pressure gauge 102 in order to effectively regulate pressure in the storage tank 108. A further advantage is that the boil-off gas/vapour 136 further cools the fuel in the storage tank 108, resulting in a reduction of boil-off from the fuel/cryogen inside the tank, and the possibility of unsteady 2-phase flow within the fuel system. The incorporation of boil-off gas 136 from the cooling substance in the cooling jacket 136 pressurises the storage tank 108 such that fuel can be delivered to the fuel system 101, wherein the fuel is still in its sub-cooled state. A flow of liquid fuel is tapped from the storage tank 108 into fuel transfer lines 114 and monitored via a mass flow meter 110. Preferably the fuel transfer lines 114 are also cooled to ensure only a flow of liquid reaches an injector 120. The fuel transfer lines 114 transport the pressurised liquid fuel to the fuel mixing means 118, for example the plenum 118. Injector nozzles 128, controlled by valves located in each nozzle and the mass flow meter 110, inject liquid fuel into the plenum 118. The liquid fuel mixes with air from air intake 104, wherein the liquid fuel starts to boil as it cools the air. This advantageously increases the density of the air intake flow and achieves cooling of the intake air flow by up to around 55° C. Cooling of the air via the fuel has a number of advantages. For example, power output of the internal combustion engine 122 is improved by increasing the density of the charge air, the generation of thermal NOx is reduced, and the allowable compression ratio and engine efficiency is maximised through the suppression of engine knock. Optional icephobic and/or hydrophobic coatings can be applied to components downstream from the injectors 128, which have an advantage of reducing/preventing accumulation of frozen water and carbon dioxide in the manifold 116 of the fuel mixing means 118 and other components for example air intake valves, and fuel injection nozzles.

The fuel-air mixture from the fuel mixing means 118 is provided to the internal combustion engine 122, where an ignition source, preferably high-energy, is used to burn the cooled fuel-air mixture, which is now in a gaseous state, and is exhausted from the internal combustion engine 122 at the end of the cycle via exhaust means 126.

Preferably, the liquid fuel injected into the fuel mixing means 118 is a cryogen, for example liquid natural gas that is sub-cooled, and also pressurised. The effect of pressurising the liquid natural gas, for example in the region of 1-15 bar, has an effect of reducing the boil-off index. In this case, the boil-off index is defined as the normalised mass loss expected at a saturation pressure of 1 bar in surroundings of 300 K for a fixed class of insulation and vessel:

$$Index = \frac{{\dot{m}}_{bo}}{{\dot{m}}_{bo @ 1 bar}}$$

$$where$$

$${\dot{m}}_{bo} = \frac{hA ( {T}_{amb} - {T}_{sat} )}{{h}_{fg}}$$

where h is the vessel's heat transfer coefficient, A is the surface area of the vessel, T_{amb} is the ambient temperature and Tₛₐₜ is the saturation temperature of the cryogen being stored, and h_{fg} is the latent heat of vaporisation of the cryogen.

Advantageously, the fuel mixing means 118 is positioned between the air intake 104 and the internal combustion engine 122. This positioning of the fuel mixing means 118 achieves the greatest possible cooling of the intake air flow within the stoichiometric limit of the fuel and creates a well premixed combustible mixture for injecting into the internal combustion engine 122.

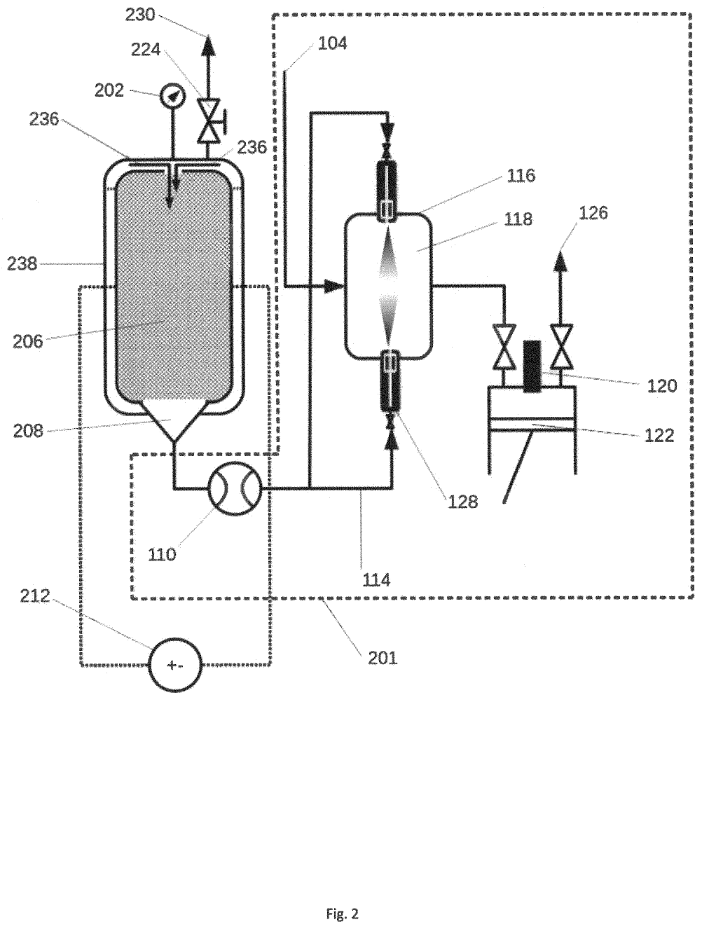

Referring to FIG. 2, a modification of the first aspect of FIG. 1 is illustrated. In this example, the storage tank 208 comprises a heating means 206, for example a conductive metal matrix, or metal foam. The heating means 206 is controlled via a controller 212 that is arranged to vary the heat output by the heating means 206. In some examples, the heating means 206 contributes to the structural integrity of the storage tank 208. Preferably the storage tank 208 in this example is arranged to store a cryogen in the form of a solid fuel, for example frozen fuel. Cooling jacket 238 is arranged to sub-cool the fuel so that it freezes by increasing the heat transfer and allowing boiling liquid in the cooling jacket 238 rather than just vapour to cool the fuel, i.e. the fuel is stored in its solid rather than liquid phase. Preferably the fuel is frozen natural gas. Boil-off from the cooling substance in the cooling jacket 238, for example liquid nitrogen is again used to pressurise the storage tank 208 containing the frozen fuel. Pressurising the tank in this way has an advantage of maintaining a positive pressure in the storage tank 208 so that oxygen is prevented from entering and contaminating the cryogen into the storage tank 208.

Storing the fuel in its solid phase has several advantages. For example, frozen gas storage has an advantage of eliminating rollover and bulk boil-off, as well as spillage and flash vaporisation. Rollover is a flash boiling hazard for liquid gas storage (specifically for gaseous mixtures), for example LNG, and has to be managed carefully. Storing the liquid fuel in its solid phase negates these issues.

In use, the controller 212 controls the heating means 206 to heat up a portion of the frozen fuel on demand Liquefied fuel is collected at the bottom of the storage tank 208 and pumped into the fuel lines 114 using the positive tank pressure caused by the incorporation of boil-off gas/vapour 236 from the substance in the cooling jacket 238. As discussed with respect to FIG. 1, a valve 224 and pressure gauge 202 are utilised by a controlling means to regulate the pressure in the storage tank 208. Using boil-off/vapour 236 from the cooling substance in the cooling jacket 236 means that separate pumping means are not required to direct high pressure fuel to the fuel transfer lines 114. This also has an advantage of keeping oxygen out of the tank. Pumping, or passive pumping, is achieved using pressure from the incorporation of the boil-off gas/vapour 236 from the substance in the cooling jacket 238, for example liquid nitrogen. This has an advantage of simplifying the system, and thus reducing costs and increasing reliability of the system. Preferably, the heating means 206 is arranged to provide homogeneous melting, and needs to account for volumetric changes in storing fuel in the solid form and the expansion that occurs during melting, which could fracture the storage tank 208 and the heating means 206. A solution to this problem is to arrange the heating means 208, which may be a metal matrix, metal foam etc., into a number of individually heated concentric rings. This has an advantage of allowing the solid fuel to be gradually melted away in layers, preventing issues relating to volumetric changes and expansion in the storage tank 208. The individually heated concentric rings may also be formed from a porous metal matrix/metal foam. The porous metal matrix may be formed from a number of alloys, which may include copper, aluminium, and stainless steels. The porous metal matrix/metal foam may be in the range of 75%-95% by volume, preferably 80% by volume, and is formed of open cell(s) to allow fluid to flow through the porous metal matrix/metal foam. An advantage of using a porous metal matrix/metal foam for the heating means 206 is that it generally has a very high internal surface area to volume ratio, which results in effective heat transfer. A further advantage of the porous metal matrix/metal foam is that it can be used as a resistive heating element, such as the individually heated concentric rings, because the ligaments of the foam are electrically conducive, or they can be inductively heated in an alternating magnetic field. The porous metal matrix/metal foam also has the advantage that it can be used for structural reinforcement.

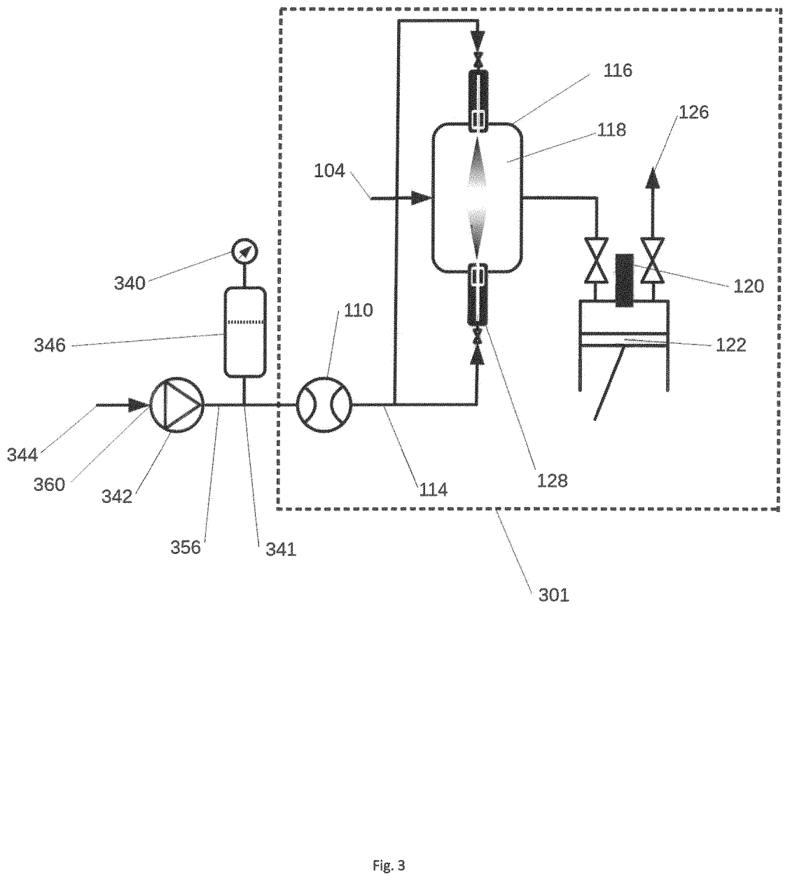

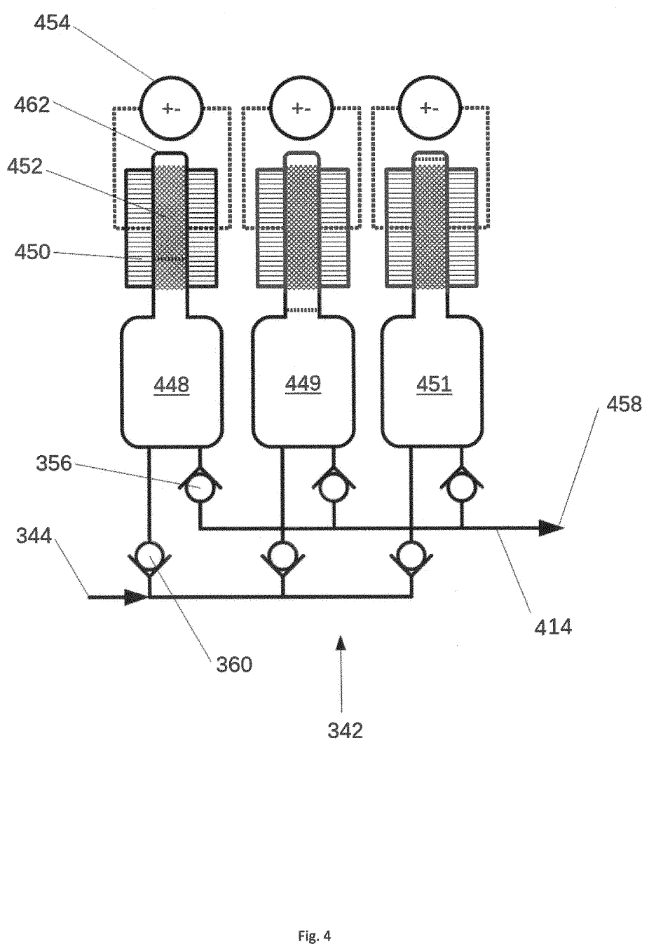

In some applications, active or separate pumping may still be required in order to provide increased delivery pressure or precise control of the fuel. FIG. 3 illustrates a simplified pumping means, for example a cryogenic pumping system 300, which will be described in more detail with respect to FIG. 4.

FIGS. 3 and 4 illustrate a second aspect of the invention, which may be combined with the first aspect of the invention, or used independently of the first aspect of the invention. FIG. 3 illustrates pumping means 342 in combination with an optional part of the fuel system 101 from FIGS. 1 and 2, now denoted 301.

Liquid fuel 344, which is preferably sub-cooled and pressurised, i.e., maintained at a high pressure, is input to pumping means 342. The liquid fuel may be output from the self-pressurising storage vessel 134, 234, or from another source. The pumping means 342, which is preferably a cryogenic pump system, comprises an inlet 360 check valve and an outlet check valve 356 to regulate the direction of the flow of the liquid fuel. Apart from these valves 360, 356, the pumping means 342 comprises no moving parts, which has an advantage of improving the reliability of the pumping means 342. The liquid fuel is subsequently pumped via pumping means 342 into an optional accumulator 346. The accumulator 346 may be used to smooth the flow and the transition between each of the pump chambers. A pressure measurement and controller (not shown) can be used to determine when the transition occurs.

In use, a cryogen, for example a liquid fuel 344, which is preferably LNG, enters the pumping means 342 from a storage vessel, for example self-pressurising storage vessel 134, 234, and passes through the inlet check valve 360 and enters a pressure chamber (see FIG. 4) 448. The pumping means 342 may comprise one or more pressure chambers 448, 449, 451. A number of pressure chambers 448, 449, 451 may be preferable as the flow of cryogen at the outlet 458 can be further smoothed as the number of pressure chambers increases. The pressure in the pressure chamber 448 is reduced using cooling means 450, for example a heat sink comprising a mesh or finned structure, or other appropriate design such as a cooling jacket as described in the previous figures. The heat sink 450 is cooled using a coolant, for example liquid nitrogen. The heat sink 450 may be arranged around a vaporising column 462, which can form part of the pressure chamber 448, wherein the heat sink 450 is arranged to condense fuel vapour residing in the vaporising column 462 from a previous pumping cycle. Alternatively, the heat sink 450 may be positioned inside the vaporising column 462, and be in contact with the vapour within the vaporising column 462. Condensing of the fuel vapour results in liquid fuel, for example LNG, being drawn into the pressure chamber 448 from the liquid fuel supply 344 until the pressure chamber 448 is full, or partially full, of liquid fuel. The flow of coolant is then removed from the heat sink 450 and a heating means 452, for example a metal heating matrix or metal foam, is enabled via controller 454. Preferably the heating means 452 is positioned inside the vaporising column 462. The heating means 452 heats and vaporises the fuel inside the vaporising column 462. Preferably, the heating means 452 only vaporises fuel in the vicinity of the vaporising column 462, and does not vaporise the bulk contents of the pressure chamber 448, by exploiting the thermal gradient created in the liquid fuel. Heating and vaporising the fuel in the vaporising column 462 results in an increase in pressure in the pressure chamber 448. The pressure in the pressure chamber increases until the pressure increases above the cracking pressure of outlet check valve 356. The outlet check valve 356 outputs pressurised liquid fuel, for example LNG, to an internal combustion engine, for example internal combustion engine 122 or a boiler or combustor, via fuel lines 414, which may be sub-cooled, and the optional accumulator 340. The accumulator 340 (see FIG. 3) may be coupled to the fuel lines 414 via a tee 341 into the line, rather than in series with the fuel lines 414. During depressurisation of the pressure chamber 448 as liquid fuel is transferred to the internal combustion engine, a portion of the liquid fuel may vaporise and is collected in the vaporising column 462. This vaporised liquid fuel collates in the vaporising column 462, which drives the liquid level down as it is slowly evaporated and remains in the vaporising column 462 until it is cooled again and liquefied and depressurised. Liquid fuel is again input to the pressure chamber 448 via inlet check valve 344 until the liquid fuel supply pressure is equal to the accumulator pressure 346. The optional accumulator may be utilised when the there is a difference between the rate at which pressurised fuel is used and when it is produced and it stores or supplies the excess flow. For example, it could be a volume with an inert gas like nitrogen at the top of pressure vessel that acts as a spring delivering flow in or out when required. When the pressures (between the chamber and the accumulator) equalise, coolant again flows through the heat sink 450 to reduce the pressure in the pressure chamber 448 for the next pump cycle. Optionally, a number of additional pressure chambers 449, 451 may be connected in parallel to provide a steady mass flow rate to the accumulator 346 and/or internal combustion engine 122.

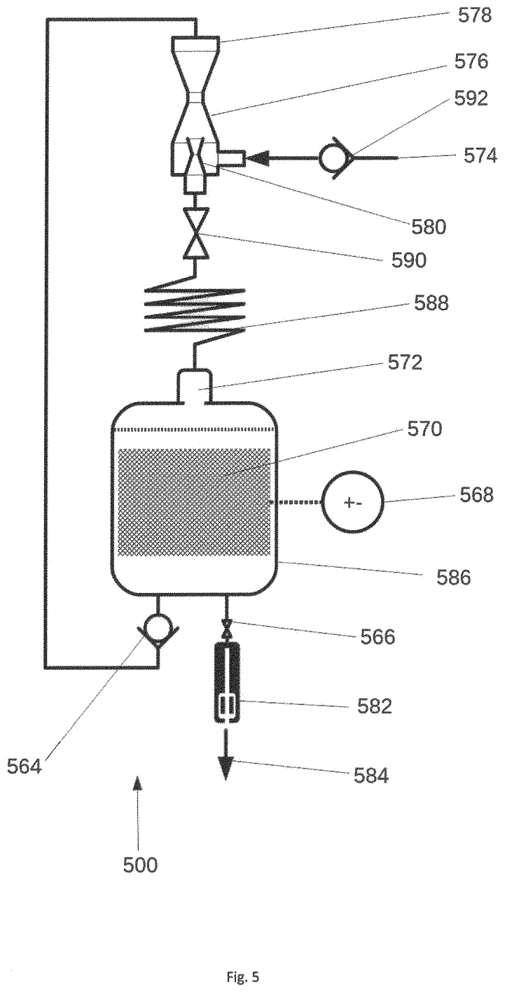

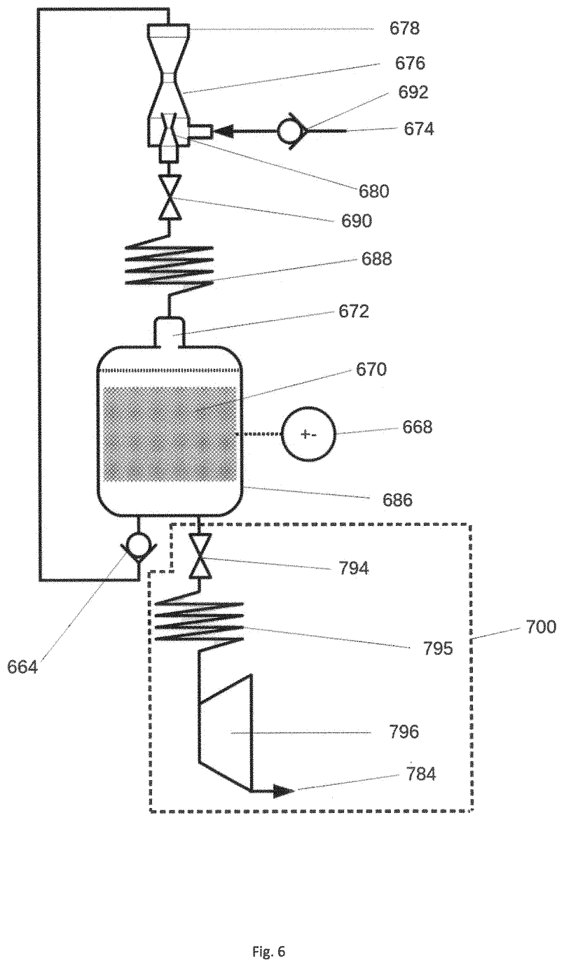

A third aspect of the invention is illustrated with respect to FIGS. 5 and 6. The third aspect may be used independently of the first and second aspects, or used in combination with the first and second aspects.

FIG. 5 illustrates an alternative pumping means 500, for example an alternative cryogenic pump. An advantage of this pumping means, which will become apparent from the below description, is that it enables continuous flow of liquid fuel, resulting in a steady mass flow rate. As described above, the second aspect of the invention requires a number of pressure chambers in order to achieve a steady mass flow rate.

Pumping means 500 comprises a pressure chamber 586 with a heating means 570. The heating means 570 may be positioned internally or externally with respect to the pressure chamber 586. The heating means 570 is controlled by power supply/controller 568. The pressure chamber 586 is arranged to hold liquid fuel, preferably sub-cooled liquid fuel such as sub-cooled LNG for example. As the fuel in the pressure chamber 586 is heated, vaporised fuel diffuses towards a top portion of the pressure chamber 586, where the vaporised fuel is collected via collection means 572, which may referred to as a collection dome. The vapour collected in the dome, which can be considered a ‘motive vapour’ (i.e., the vapour is used to draw cryogen, preferably in liquid form, into the acceleration means 580) is fed into an acceleration means 580, for example a Laval nozzle. Optionally, the vapour that is fed into the acceleration means 580 may first be heated via a further heating means 588, for example a superheating coil. The optional heating means 558 may provide optimal pumping efficiency. If the vapour is too wet the device may struggle to raise pressure. If the liquid is not sub cooled, boiling two-phase liquid exits the pump. The vapour fed into the acceleration means 580 may also be controlled via valve 590 to control the flow of vapour. The accelerating means 580 accelerates the vapour, which reduces the pressure of the vapour in the accelerating means 580. The accelerated vapour is then mixed/entrained with liquid fuel from a fuel storage means 574, which may be the same liquid fuel that is stored in the pressure chamber 586. Preferably, this liquid fuel is sub-cooled and maintained at a low pressure. This fuel may be provided by the self-pressurising storage vessel from the first aspect described above. A check valve 592 may be utilised to ensure a correct flow of liquid fuel is mixed with the vapour. Further mixing of the vapour and the liquid fuel occurs in mixing means 576, wherein the vapour, i.e., vaporised fuel from the storage tank 586, rapidly condenses amid the inflow of the liquid fuel, which is preferably sub-cooled. This entrained fuel, comprising condenses vapour and liquid fuel from storage means 574 is then decelerated in decelerating means 578, which raises the pressure of the entrained fuel above that of the pressure chamber 586. This high pressure entrained fuel (if the fuel in the pressure chamber 586 and storage means 574 is the same, for example LNG, then the entrained fuel relates to sub-cooled high pressure LNG for example), flows through check valve 565 when the pressure of the fuel is above that of the check valve 565. The flow of high pressure fuel into the pressure chamber 586 via the check valve 565 results in high pressure liquid fuel being tapped from the pressure chamber 568 at regulator valve 566. The high pressure liquid fuel can for example be input to a spray nozzle 582, which may form part of a natural gas engine or boiler or combustor which also requires a steady flow of liquid. Advantageously, the pumping means 500 enables continuous steady flow of high pressure sub-cooled liquid fuel to the spray nozzle 582.

FIG. 6 illustrates a modification of the third aspect discussed in FIG. 5. FIG. 6 illustrates a turboexpander system 700 positioned between pressure chamber 568 and the spray nozzle (not illustrated). The turboexpander system 700 comprises a turboexpander 796, which enables energy recovery by pressurising, heating, via coil 795, and expanding the fuel to produce additional power, before the fuel is input at 784 to a gas injector nozzle or an engine or boiler for example. The turboexpander 796 may include a valve 794 to regulate the flow of fuel. The turboexpander 796 advantageously provides energy recovery during regasification at a gas terminal.

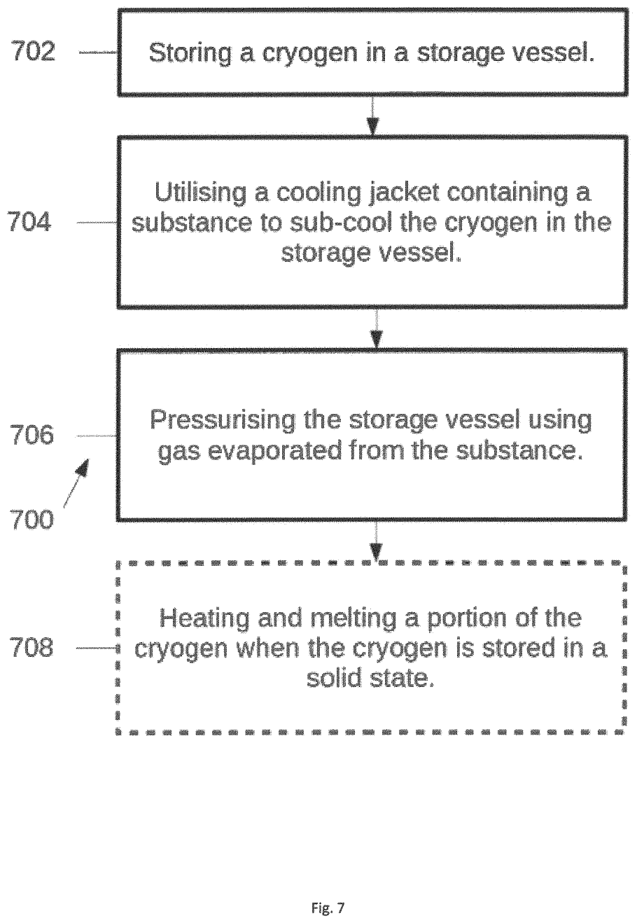

FIG. 7 illustrates a flow chart 700 for pressurising a storage vessel, for example the self pressurising storage vessel from the first aspect of the invention relating to FIGS. 1 and 2. At 702, the storage vessel stores a cryogen, for example a liquid fuel, preferably LNG. At 704, a cooling jacket comprising a substance for cooling, preferably sub-cooling, the cryogen is utilised to cool the fluid. At 706 the storage vessel is pressurised by injecting gas evaporated by the substance in the cooling jacket, as a result of the cooling process, into the storage vessel in order to passively pump cryogen out of the storage vessel. Optionally, at 708, if the cryogen is stored in a solid phase/state by sub-cooling the cryogen, a portion of the cryogen may be heated and melted to enable passive pumping out of the storage vessel.

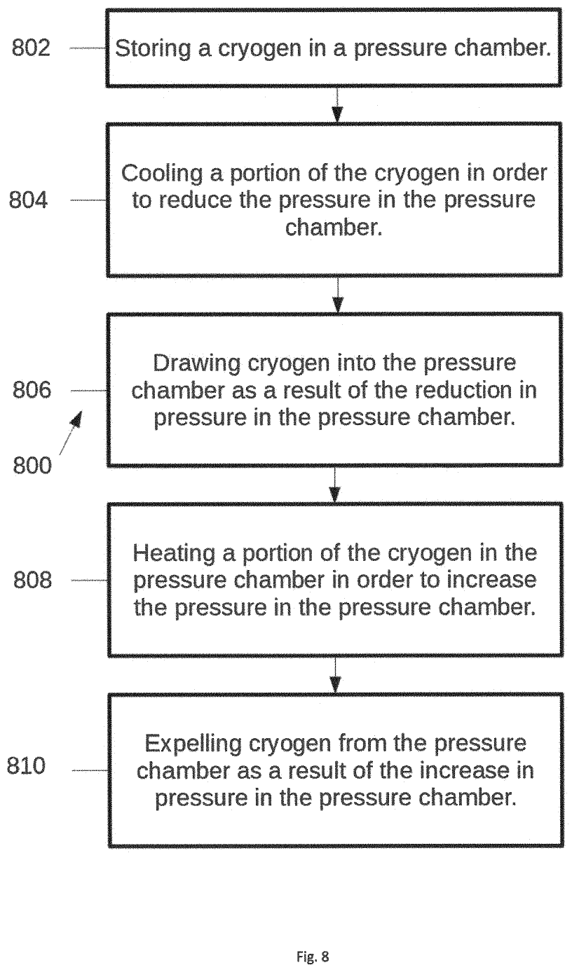

FIG. 8 illustrates a flow chart 800 for pumping a cryogen. FIG. 8 relates to the apparatus described with respect to FIGS. 3 and 4. At 802, a cryogen is stored in a pressure chamber. At 804, a portion of the stored cryogen in the pressure chamber is cooled in order to reduce the pressure in the pressure chamber. At 806, more cryogen is drawn into the pressure chamber as a result of the reduction in pressure in the pressure chamber. At 808, a portion of the cryogen in the pressure chamber is heated in order to increase the pressure in the pressure chamber. At 810, cryogen is expelled from the pressure chamber as a result of the increase in pressure in the pressure chamber.

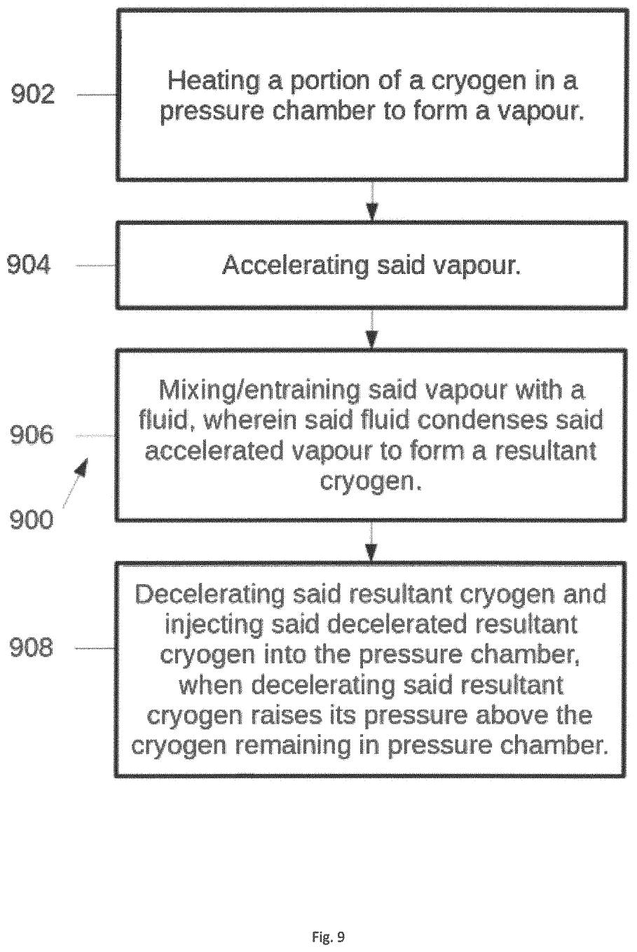

FIG. 9 illustrates a flow chart 900 for pumping a cryogen. FIG. 9 relates to the apparatus described with respect to FIGS. 5 and 6. At 902, a portion of a cryogen in a pressure chamber is heated so that a portion of the cryogen is vaporised. At 904, the vaporised cryogen is accelerated. At 906, the accelerated vapour is mixed/entrained with a fluid, wherein the fluid condenses the accelerated vapour to form a resultant cryogen. At 908, the resultant cryogen is decelerated and injected into the pressure chamber, wherein the decelerated resultant cryogen has a pressure above that of the remaining cryogen in the pressure chamber.

The above aspects relate to devices and systems for liquefied gas storage and injection. Aspects and examples have been described in combination with a boiler or internal combustion engine. We note that any suitable gas engine can be utilised with the disclosed aspects and examples of the invention.

### Further Examples of the Invention

1. A self-pressurising storage vessel (134) comprising:
a storage tank (108) for storing a cryogen; and
a cooling jacket (138), wherein the cooling jacket (138) is for holding a substance suitable for cooling the cryogen, arranged such that, in use, vapour evaporated from the substance in the cooling jacket (138) pressurises the storage tank.

2. The self-pressurising storage vessel of example 1, wherein the cooling jacket is positioned around and in contact with said storage tank.

3. The self-pressurising storage vessel of example 1 or 2, comprising control means for feeding vapour from the cooling jacket into the storage tank, utilising a valve and pressure gauge to maintain a positive pressure in the storage tank.

4. The self-pressurising storage vessel of any preceding example, wherein the cooling jacket sub-cools the cryogen.

5. The self-pressurising storage vessel of example 4, comprising sub-cooled cryogen in the solid and/or liquid phase.

6. The self pressurising storage vessel of any preceding example, wherein the substance is liquid nitrogen, LN2, and wherein the cryogen is one of methane, liquid natural gas, LNG, propane or butane.

7. The self pressurising storage vessel of any preceding example, wherein the storage tank further comprises a heating means.

8. The self pressurising storage vessel of example 7, wherein the heating means comprises a number of individually controlled/heated concentric rings situated within the storage tank.

9. The self pressurising storage vessel of example 8, wherein the individually controlled/heated concentric rings are formed of a porous metal matrix.

10. An internal combustion engine comprising the self pressurising storage vessel of any one of examples 1 to 9.

11. A method (700) for pressurising a storage vessel, the method comprising:
storing (702) a cryogen in a storage vessel;
utilising (704) a cooling jacket to cool the cryogen in the storage vessel, the cooling jacket comprising a substance suitable for cooling the cryogen; and
pressurising (706) the storage vessel using vapour evaporated from the substance.

12. A thermo-fluidic pump arrangement (342) comprising:
a pressure chamber (448) for holding a cryogen;
a heating means (452); and
a cooling means (450);
wherein the cooling means (450) is arranged to sub-cool a portion (462) of the pressure chamber (448) in order to reduce the pressure in the pressure chamber (448) so as to draw a cryogen into the pressure chamber (448); and
wherein the heating means (452) is arranged to heat the portion (462) of the pressure chamber (448) in order to increase the pressure in the pressure chamber so as to expel the cryogen from the pressure chamber (448).

13. The thermo-fluidic pump arrangement of example 12, wherein the cryogen is sub-cooled fuel, wherein the sub-cooled fuel is one of methane, liquid natural gas, LNG, propane or butane.

14. The thermo-fluidic pump arrangement of examples 12 or 13, wherein the pressure chamber comprises a vaporising column (462), wherein the heating means and cooling means are arranged at the vaporising column.

15. The thermo-fluidic pump arrangement of example 12, wherein the heating means is arranged to be in contact with cryogen in the pressure chamber, and wherein the cooling means is arranged to be in contact with the vaporising column.

16. An internal combustion engine comprising the thermo-fluidic pump arrangement of any one of examples 12 to 15.

17. An internal combustion engine comprising the self pressurising storage vessel of any one of examples 1 to 11 and the thermo-fluidic pump arrangement of any one of examples 12 to 15.

18. A method (800) for pumping a cryogen, the method comprising:
storing (802) a cryogen in a pressure chamber;
cooling (804) a portion of the cryogen in the pressure chamber in order to reduce the pressure in the pressure chamber;
drawing (806) cryogen into the pressure chamber as a result of the reduction in pressure in the pressure chamber;
heating (808) a portion of the cryogen in the pressure chamber in order to increase the pressure in the pressure chamber; and
expelling (810) cryogen from the pressure chamber as a result of the increase in pressure in the pressure chamber.

19. A cooling jacket (138) for a storage tank, wherein the cooling jacket (138) is for positioning around said storage tank, wherein said cooling jacket (138) is for holding a substance suitable for cooling a cryogen, wherein vapour evaporated from the substance in the cooling jacket pressurises the storage tank.

20. A thermo-fluidic pump arrangement comprising:
a pressure chamber (586) for holding a cryogen
heating means (570);
vapour accelerating means (580);
decelerating means (578); and
pumping means (576);
wherein the heating means (570) is arranged to vaporise a portion of the cryogen in the pressure chamber, said vapour being forwarded to the vapour accelerating means (580);
said pumping means (576) arranged to receive said accelerated vapour and arranged to facilitate mixing of said accelerated vapour with a fluid, wherein said fluid condenses said accelerated vapour in said pump means to form a resultant cryogen, said resultant cryogen being decelerated by said decelerating means and input into the pressure chamber at a pressure higher than the cryogen remaining in the pressure chamber.

21. A method (900) for pumping a cryogen, the method comprising:
heating (902) a portion of a first cryogen in a pressure chamber to form a vapour;
accelerating (904) said vapour;
mixing (906) said accelerated vapour with a fluid, wherein said fluid condenses said accelerated vapour to form a resultant cryogen;
decelerating said resultant cryogen and injecting into the pressure chamber,
   wherein decelerating said resultant cryogen raises its pressure above that of the remaining first cryogen in the pressure chamber.

22. The method of example 21, wherein the cryogen and the fluid are the same liquid fuel.

23. The method of example 22, wherein the fluid is sub-cooled.

24. An internal combustion engine comprising the thermo-fluidic pump arrangement of example 20.

25. An internal combustion engine comprising the self pressurising storage vessel of any one of examples 1-11 and the thermo-fluidic pump arrangement of example 20.

1. A self-pressurising storage vessel (134) comprising:
a storage tank (108) for storing a cryogen; and
a cooling jacket (138), wherein the cooling jacket (138) is for holding a substance suitable for cooling the cryogen, arranged such that, in use, vapour evaporated from the substance in the cooling jacket (138) pressurises the storage tank.

2. The self-pressurising storage vessel of claim 1, wherein the cooling jacket is positioned around and in contact with said storage tank.

3. The self-pressurising storage vessel of claim 1, comprising control means for feeding vapour from the cooling jacket into the storage tank, utilising a valve and pressure gauge to maintain a positive pressure in the storage tank.

4. The self-pressurising storage vessel of claim 1, wherein the cooling jacket sub-cools the cryogen.

5. The self-pressurising storage vessel of claim 4, comprising sub-cooled cryogen in the solid and/or liquid phase.

6. The self pressurising storage vessel of claim 1, wherein the substance is liquid nitrogen, LN2, and wherein the cryogen is one of methane, liquid natural gas, LNG, propane or butane.

7. The self pressurising storage vessel of claim 1, wherein the storage tank further comprises a heating means.

8. The self pressurising storage vessel of claim 7, wherein the heating means comprises a number of individually controlled/heated concentric rings situated within the storage tank.

9. The self pressurising storage vessel of claim 8, wherein the individually controlled/heated concentric rings are formed of a porous metal matrix.

10. A method (700) for pressurising a storage vessel, the method comprising:
storing (702) a cryogen in a storage vessel;
utilising (704) a cooling jacket to cool the cryogen in the storage vessel, the cooling jacket comprising a substance suitable for cooling the cryogen; and
pressurising (706) the storage vessel using vapour evaporated from the substance.

11. A cooling jacket (138) for a storage tank, wherein the cooling jacket (138) is for positioning around said storage tank, wherein said cooling jacket (138) is for holding a substance suitable for cooling a cryogen, wherein vapour evaporated from the substance in the cooling jacket pressurises the storage tank.
